(19) United States
(12) Patent Application Publication
(10) Pub. No.: US 2020/0158891 A1
(43) Pub. Date: May 21, 2020

(54) Low-Power Multi-Channel Analyzer for Portable Radiation Systems

(71) Applicants: Sunil P. Khatri, College Station, TX (US); Craig M. Marianno, College Station, TX (US); Ronald Evan Guise, Logandale, NV (US)

(72) Inventors: Sunil P. Khatri, College Station, TX (US); Craig M. Marianno, College Station, TX (US); Ronald Evan Guise, Logandale, NV (US)

(73) Assignee: The Texas A&M University System, College Station, TX (US)

(21) Appl. No.: 16/611,043

(22) PCT Filed: May 10, 2018
(86) PCT No.: PCT/US2018/032053

§ 371 Date: Nov. 5, 2019

Related U.S. Application Data
(60) Provisional application No. 62/504,116, filed on May 10, 2017.

(51) Int. Cl. G01T 1/17; G01T 1/02

(52) U.S. Cl. CPC G01T 1/17; G01T 1/02

(57) ABSTRACT

Provided herein are multi-channel analyzers (MCA) designed for radiation detections systems. The MCA has an application specific single-chip structure of an integrated circuit chip with at least one instance of the MCA that has a plurality of MCA functions integrated thereon. An analog-to-digital converter and/or a microcontroller unit may be integrated on the chip to reduce the footprint and power and energy consumption.

### CROSS-REFERENCE TO RELATED APPLICATIONS

This application claims benefit of priority under 35 U.S.C. § 119(e) of provisional application U.S. Ser. No 62/504,116, filed May 10, 2017, the entirety of which is hereby incorporated by reference.

### FEDERAL FUNDING LEGEND

This invention was made with government support under contract number HDTRA1-12-C-0063 awarded by the Defense Threat Reduction Agency. The government has certain rights in the invention.

### BACKGROUND OF THE INVENTION

### Field of the Invention

The present invention relates to the field of design of radiation detection systems. More specifically, the present invention relates to a low-power multichannel analyzer that consumes significantly less power than a traditional multichannel analyzer.

### Description of the Related Art

A traditional scintillation based gamma detection radiation system generally comprises four essential components, including a scintillation crystal that glows when a gamma ray impinges on it, a photocathode that converts the light into free electrons, a photomultiplier tube (PMT) that amplifies the electron current so that it can be measured, and an end-cap that performs signal conditioning and transmits this information to a data collection system.

The end-cap is one of the most critical components of a scintillation-based gamma radiation system. Many end-caps are as simple as a pre-amplifier that connects to a multi-channel analyzer (MCA). Current end-caps are designed using discrete electronic components that take up a significant amount of space, and are generally highly energy consuming, preventing the development of a portable gamma radiation detection system. The MCA can be used in radiation detection systems that detect other than gamma radiation as well.

Therefore, there is a recognized need in the art for an MCA designed for a radiation detection system. Particularly, the prior art is deficient in an end-cap which has a significantly smaller volume and is less energy demanding than the traditional end-cap. The present invention fulfills this long-standing need and desire in the art.

### SUMMARY OF THE INVENTION

The present invention is directed to a multi-channel analyzer for a radiation detection system. The multi-channel analyzer comprises an application specific integrated circuit (ASIC) chip that has at least one instance of the multi-channel analyzer with a plurality of multi-channel analyzer functions integrated thereon, where the ASIC chip is in electrical connection with a microcontroller interfaced with a host electronic device. The present invention is directed to related multi-channel analyzers that further comprise an analog-to-digital converter (ADC) or a microcontroller unit (MCU) or both an analog-to-digital converter (ADC) and a microcontroller unit (MCU) integrated therein. The present invention is directed to another related multi-channel analyzer that further comprises a GPS integrated therein. The present invention is directed to yet another related multi-channel analyzer that further comprises at least one event counter.

The present invention also is directed to a multi-channel analyzer for a radiation detection system. The multi-channel analyzer comprises a multi-functional application specific integrated circuit (ASIC) chip integrating thereon at least one of an analog-to-digital converter and a microcontroller unit and comprising circuitry configured to enable one or more multi-channel analyzer functions. The present invention is directed to a related multi-channel analyzer that further comprises a GPS integrated therein and configured to track a location of the MCA or a location of signals collected by the MCA or a combination thereof. The present invention is directed to another related multi-channel analyzer that further comprises at least one event counter. The present invention is directed to yet another related multi-channel analyzer that further comprises a double buffered memory in electrical communication with the ASIC chip.

The present invention is directed further to a multi-channel analyzer for a radiation detection system. The multi-channel analyzer comprises a multi-functional application specific integrated circuit chip with circuitry configured to enable functions to, inter alia, synchronize a plurality of detectors in the radiation detection system to collect data therefrom, detect and reject pulse irregularities in electronic signals resulting from detection of the radiation, adjust gain to achieve gain stabilization to record radiation peaks in a same channel, capture two types of radiation signals, sum or discount signals registered within a specific time-gate, and interface with a host computer. A double buffered memory is in electrical communication with the ASIC chip and a microcontroller circuitry is in electrical connection with the ASIC chip and the host computer. The present invention is directed to related multi-channel analyzers that further comprise an analog-to-digital converter (ADC) or a microcontroller unit (MCU) or both an analog-to-digital converter (ADC) and a microcontroller unit (MCU) integrated therein. The present invention is directed to another related multi-channel analyzer that further comprises GPS integrated therein and configured to track a location of the multi-channel analyzer or a location of signals collected by the multi-channel analyzer or a combination thereof. The present invention is directed to yet another related multi-channel analyzer that further comprises at least one event counter.

### BRIEF DESCRIPTION OF THE DRAWINGS

So that the matter in which the above-recited features, advantages and objects of the invention, as well as others that will become clear, are attained and can be understood in detail, more particular descriptions of the invention briefly summarized above may be by reference to certain embodiments thereof that are illustrated in the appended drawings. These drawings form a part of the specification. It is to be noted, however, that the appended drawings illustrate preferred embodiments of the invention and therefore are not to be considered limiting in their scope.

FIG. 1 is a radiation spectrum showing the number of counts for each energy channel over time.

FIGS. 2A-2B show the schematics of the interaction between radiation data and the memory integrated in the MCA ASIC (application-specific integrated circuit) chip structure. FIG. 2A is the schematic of a single memory processing incoming and outgoing data. FIG. 2B is the schematic of the double buffered memory that can process incoming and outgoing data at the same time.

FIG. 3 shows the coincidence mode of the MCA showing the schematic of radiation split into multiple detectors.

FIGS. 4A-4C show the histograms when the gain on the pre-amplifier changes. FIG. 4A shows the histogram scaling, which means the histogram compacts or expands horizontally. FIG. 4B is a normal histogram produced by the MCA without changes of the gain. FIG. 4C shows the histogram shifting, which means the histogram moves horizontally.

FIGS. 5A-5B are the schematics of pulse pile up in comparison with no pulse pile up. FIG. 5A shows the normal decodable reading of the detector without pulse pile up. FIG. 5B shows an un-decodable reading caused by the pulse pile up condition.

FIG. 6 is the timing diagram for the MCA when it receives detector data.

FIGS. 7A-7B are timing diagrams illustrating when the micro controller writes to the MCA without a data packet (FIG. 7A) or with a data packet (FIG. 7B).

FIG. 8 is a timing diagram describing the process of the MCA reading out to micro controller.

FIG. 9 is a timing diagram for the MCA any time an error is detected.

FIGS. 10A-10C are timing diagrams for the MCA when critical errors occur. FIG. 10A illustrates the interaction between the micro controller and the MCA when a critical error is detected. FIG. 10B is an expansion of the Assess Errors and Correct Errors in the FIG. 10A timing diagram. FIG. 10C illustrates the command Set Gain Stabilization Window Width.

FIGS. 11A-11B are timing diagrams for the MCA when non-critical errors occur. FIG. 11A illustrates when the micro controller attempts to Read Pulse Pile Up Counter when it is disabled and the MCA signals Error Interrupt. FIG. 11B illustrates that the micro controller then reads the Error Registers to identify the error.

FIG. 12 is a timing diagram for the MCA when resetting parameters and/or modes.

FIG. 13 is a timing diagram for the MCA when changing the parameters.

FIG. 14 is a histogram showing the gain stabilization channel, and gain stabilization window width.

FIGS. 15A-15B are timing diagrams describing pulse pile up distinction. FIG. 15A shows a timing diagram where two energy peak detected input pulses appear in a single Logic Ladder diagram input/ADC busy cycle. FIG. 15B shows a timing diagram where three energy peak detected input pulses appear in a single LLD input/ADC busy cycle.

### DETAILED DESCRIPTION OF THE INVENTION

As used herein in the specification, “a” or “an” may mean one or more. As used herein in the claim(s), when used in conjunction with the word “comprising”, the words “a” or “an” may mean one or more than one.

As used herein “another” or “other” may mean at least a second or more of the same or different claim element or components thereof. Similarly, the word “or” is intended to include “and” unless the context clearly indicates otherwise. “Comprise” means “include”.

As used herein, the term “about” refers to a numeric value, including, for example, whole numbers, fractions, and percentages, whether or not explicitly indicated. The term “about” generally refers to a range of numerical values (e.g., +/−5-10% of the recited value) that one of ordinary skill in the art would consider equivalent to the recited value (e.g., having the same function or result). In some instances, the term “about” may include numerical values that are rounded to the nearest significant figure.

As used herein, the terms “computer”, “computer system” or “smart device” refer to any electronic device comprising at least a memory, a processor, a display and at least one wired or wireless network connection. As is known in the art, the processor is configured to execute instructions comprising any software programs or applications or processes tangibly stored in computer memory or tangibly stored in any known computer-readable medium.

As used herein, the term “radiation system” refers to any portable radiation detection system including a hand-held radiation detection system.

In one embodiment of the present invention, there is provided a multi-channel analyzer for a radiation detection system comprising an application specific integrated circuit chip (ASIC) comprising at least one instance of the multi-channel analyzer with a plurality of multi-channel analyzer functions integrated thereon, the ASIC chip in electrical connection with a microcontroller interfaced with a host electronic device. Further to this embodiment the ASIC chip may comprise an analog-to-digital converter integrated therein. In another further embodiment the ASIC chip may comprise a microcontroller unit integrated therein. In yet another further embodiment the ASIC chip may comprise an analog-to-digital converter and a microcontroller unit integrated therein. In yet another further embodiment the ASIC chip may comprise a GPS integrated therein. In yet another further embodiment the ASIC chip may comprise at least one event counter.

In all embodiments the multi-channel analyzer may have a direct memory access mode. Also, in all embodiments the multi-channel analyzer may be operating system agnostic. In addition, the host electronic device may be a computer, a laptop computer, a tablet computer, a smart phone, or other electronic device.

In one aspect of all embodiments the ASIC chip may comprise a double buffered memory integrated therein. In another aspect of all embodiments the ASIC chip may be configured to enable a synchronized readout function. In yet another aspect the ASIC chip may be configured to enable a rejection of pulse pile up function. In yet another aspect the ASIC chip may be configured to enable a gain stabilization function. In this particular aspect the gain stabilization function may enable an algorithm comprising processor-executable instructions to maintain a gain threshold.

In yet another aspect the ASIC chip may be configured to enable a dual detection of radiation signals function. In yet another aspect the ASIC chip may be configured to enable a coincidence counting function. In yet another aspect the ASIC chip may be configured to enable a voltage multiplier to use a full cycle of AC current. In yet another aspect the ASIC chip may be configured to enable a voltage scaling function. In yet another aspect the ASIC chip may be configured to enable a list-mode function to time stamp and report events. In yet another aspect the ASIC chip may be configured to enable an analog-to-digital signal conversion. In yet another aspect the ASIC chip may be configured to enable a voltage scale for a deep-sleep mode for significantly low power and energy consumption. In yet another aspect the ASIC chip may be configured to enable a digital-to-analog signal conversion. In yet another aspect the ASIC chip may comprise 2 or more instances of the multi-channel analyzer.

In another embodiment of the present invention there is provided a multi-channel analyzer for a radiation detection system comprising a multi-functional application specific integrated circuit (ASIC) chip integrating thereon at least one of an analog-to-digital converter and a microcontroller unit and comprising circuitry configured to enable one or more multi-channel analyzer functions.

Further to this embodiment embodiment the multi-channel analyzer may comprise a GPS integrated therein and configured to track a location of the MCA or a location of signals collected by the MCA or a combination thereof. In another further embodiment the multi-channel analyzer may comprise at least one event counter. In yet another further embodiment the multi-channel analyzer may comprise a double buffered memory in electrical communication with the ASIC chip.

In all embodiments the multi-channel analyzer may have a direct memory access mode. Also in all embodiments the multi-channel analyzer may be operating system agnostic. In addition to all embodiments the ASIC circuitry may be configured to enable one or more multi-channel analyzer functions to synchronize a plurality of detectors in the radiation detection system to collect data therefrom; to detect and reject pulse irregularities in electronic signals resulting from detection of the radiation; to adjust gain to achieve gain stabilization to record radiation peaks in a same channel; to capture two types of radiation signals; sum or discount signals registered within a specific time-gate; and to interface with a host computer. Particularly, the ASIC chip circuitry may be configured to achieve gain stabilization via an algorithm comprising processor-executable instructions to maintain a gain threshold.

Further to these multi-channel analyzer functions the ASIC chip circuitry may be configured to achieve gain stabilization via an algorithm comprising processor-executable instructions to maintain a gain threshold. Further still the ASIC chip circuitry may be configured to enable a function to eliminate current sag. Further still the ASIC chip circuitry may be configured to enable a function to a list-mode function to add time stamps to individual events in multiple detectors and to report events. Further still the ASIC chip circuitry may be configured to enable a function to use a full cycle of AC current in a voltage multiplier. Further still the ASIC chip circuitry may be configured to enable a function to scale voltage for a deep-sleep mode for significantly low power and energy consumption. Further still the ASIC chip circuitry may be configured to enable a function to convert an analog signal to a digital signal, to convert a digital signal to an analog signal or a combination thereof.

In yet another embodiment of the present invention there is provided a multi-channel analyzer for a radiation detection system comprising a multi-functional application specific integrated circuit chip with circuitry configured to enable one or more functions to: synchronize a plurality of detectors in the radiation detection system to collect data therefrom; detect and reject pulse irregularities in electronic signals resulting from detection of the radiation; adjust gain to achieve gain stabilization to record radiation peaks in a same channel; capture two types of radiation signals; sum or discount signals registered within a specific time-gate; and interface with a host computer; a double buffered memory in electrical communication with the ASIC chip; and a microcontroller circuitry in electrical connection with the ASIC chip and the host computer.

Further to this embodiment the multi-channel analyzer may comprise an analog-to-digital converter integrated therein. In another further embodiment the multi-channel analyzer may comprise a microcontroller unit integrated therein. In yet another further embodiment the multi-channel analyzer may comprise an analog-to-digital converter and a microcontroller unit integrated therein. In yet another further embodiment, the multi-channel analyzer may comprise a GPS integrated therein and configured to track a location of the multi-channel analyzer or a location of signals collected by the multi-channel analyzer or a combination thereof. In yet another further embodiment, the multi-channel analyzer may comprise at least one event counter. In all embodiments the multi-channel analyzer may have a direct memory access mode. Also in all embodiments the multi-channel analyzer may be operating system agnostic.

In one aspect of all embodiments ASIC chip circuitry may be configured to achieve gain stabilization via an algorithm comprising processor-executable instructions to maintain a gain threshold. In another aspect of all embodiments the ASIC chip circuitry may be further configured to enable a function to eliminate current sag. In yet another aspect the ASIC chip circuitry may be further configured to enable a list-mode function to add time stamps to individual events in multiple detectors and to report events. In yet another aspect the ASIC chip circuitry may be further configured to enable a function to use a full cycle of AC current in a voltage multiplier. In yet another aspect the ASIC chip circuitry may be further configured to enable a function to scale voltage for a deep-sleep mode for significantly low power and energy consumption. In yet another aspect the ASIC chip circuitry may be further configured to enable a function to convert an analog signal to a digital signal, to convert a digital signal to an analog signal or a combination thereof.

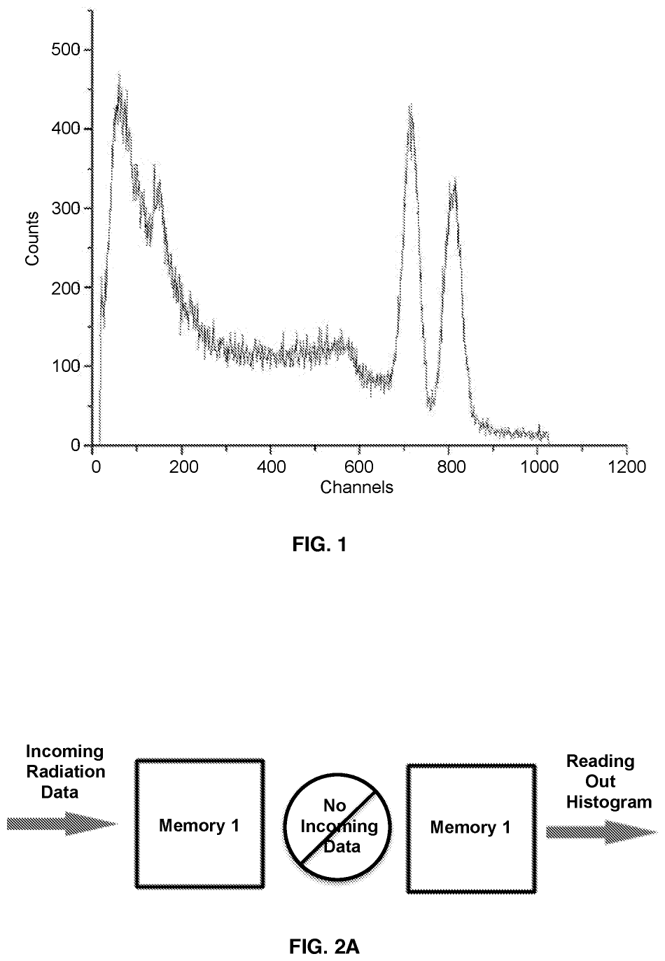

Provided herein is a multi-channel analyzer (MCA). In the embodiments described herein the MCA may require a significantly smaller space and may consume significantly less power and energy than traditional MCA radiation detection systems currently as known in the art. The MCA ASIC may comprise at least MCA circuitry, microcontroller circuitry including analog-to-digital conversion circuitry and digital-to-analog conversion circuitry, a double buffered memory, and other circuitry and features as described herein. The MCA ASIC is designed to generate radiation spectra (FIG. 1). The microcontroller circuit interfaces between the multichannel analyzer and a host electronic device, such as, but not limited to a computer, a laptop computer or a smart device, such as a tablet computer or a smart phone.

The MCA ASIC may have a single-chip structure for all the circuitry including microcontroller and/or the analog-to-digital converter and memories described, eliminating the need for multiple chips on the system board and thus reducing the footprint of the board and the energy and the power consumption of the system, for example, extending battery life. An alternative configuration of the MCA ASIC may comprise a plurality of instances (typically 2 or 4) of the MCA integrated on a single integrated circuit chip. The MCA ASIC may be realized as a single Very-Large-Scale-Integration integrated (VLSI) circuit.

For example, a single chip with double the memory can be implemented on a 130 nm fabrication process. By using a 65 nm fabrication process, four instances of the MCA can be integrated on a single integrated chip. With a 90 nm fabrication process, two instances of the MCA can be integrated on a single integrated chip, allowing 1 chip to monitor a maximum of four different detectors.

Overall, the MCA ASIC is configured to achieve multiple advantages over the traditional end-cap MCAs. For example, the MCA ASIC may realize one or more of the following features.

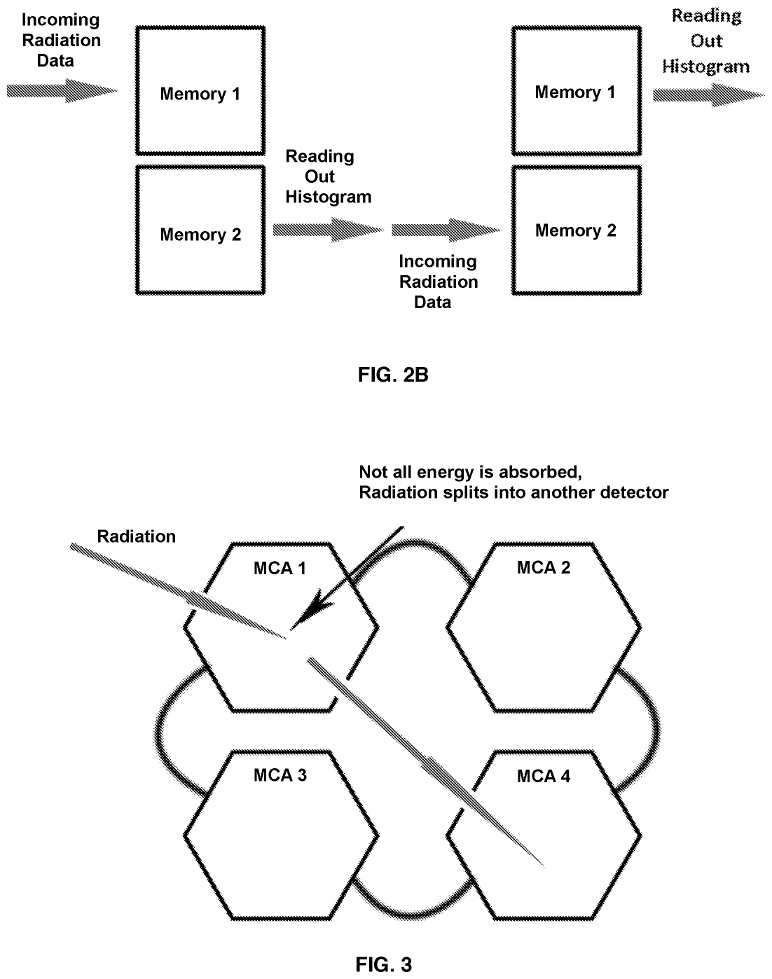

(a) Double buffered memory. This may be integrated into the MCA ASIC structure. In a traditional end-cap, data is either being collected by the detector and stored in memory or being read from memory and written to the acquisition system. In a traditional memory, when data is being read from the memory, radiation fields are not stored, and detector data is ignored. To avoid such a drawback, two memory areas (buffers) are utilized in the MCA ASIC (FIGS. 2A-2B). The double buffered memory is configured to enable the system to use one memory section acquire data from the detector, and the other memory section pushing data to the acquisition system. The two memory sections continuously flip-flop to maintain data continuity. Detector data is therefore never ignored in such a system.

(b) Synchronized readout. This MCA is configured to enable arrays of detectors in the radiation detection system that uses the MCA to be synchronized as they acquire spectral data.

(c) Rejection of pulse pile up. When radiation is registered in a detector even at moderate rates, the resulting electronic signal can get distorted. This is called “pulse pile up” and causes erroneous features on the spectra, potentially resulting in missed radionuclides. The MCA of the present invention is configured to detect these pulse irregularities and to reject them. This allows “cleaner” spectra to be collected, even in high radiation fields. See FIGS. 5A-5B.

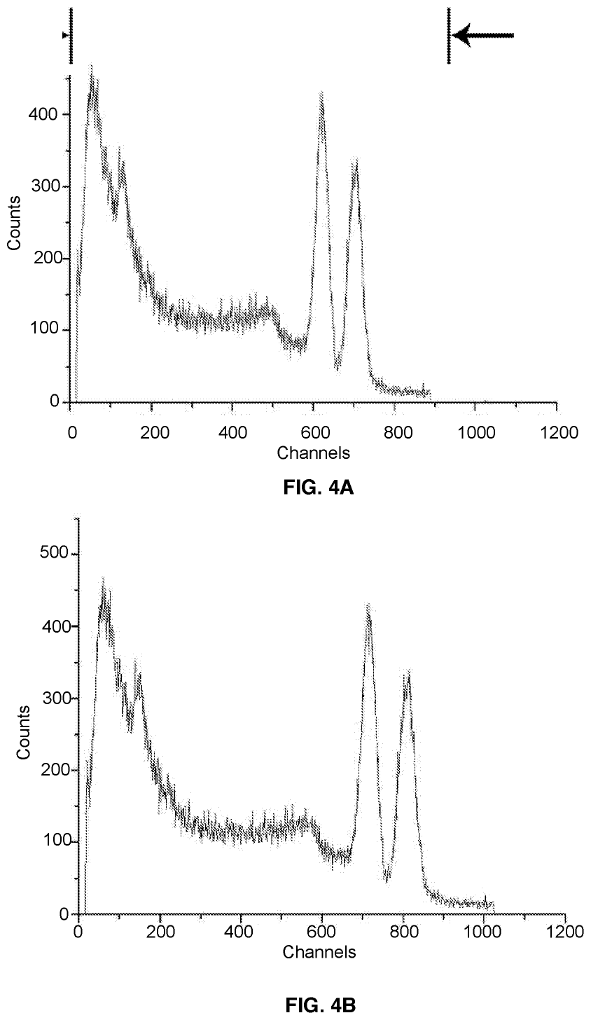

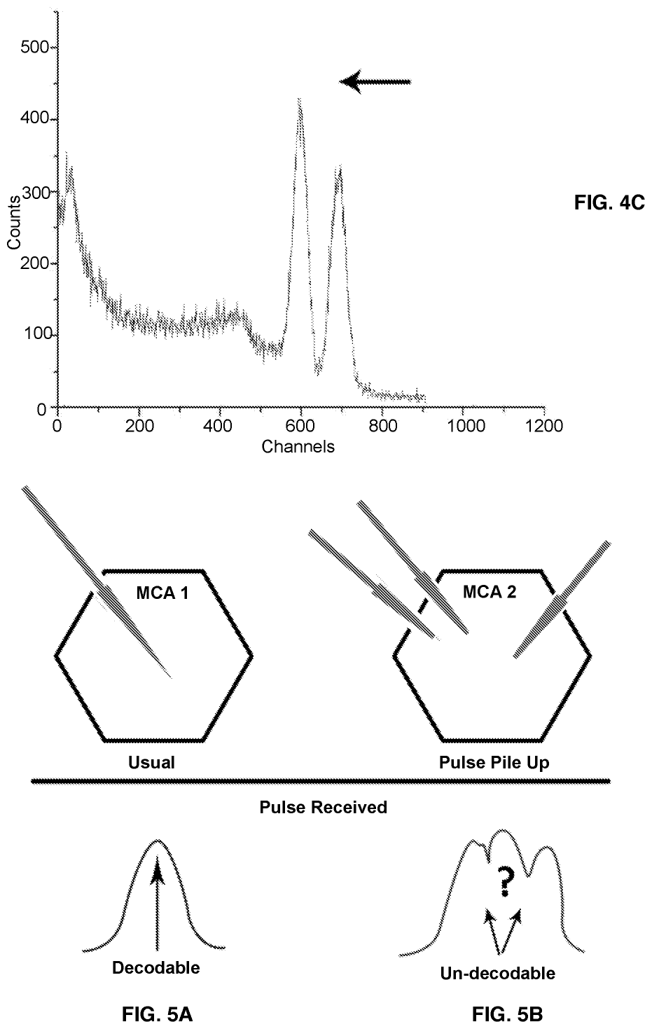

(d) Gain stabilization. As detector system electronics get warm, the gain associated with the amplifier may drift. The drift causes spectral features to move in the recorded histograms. The MCA of the present invention is configured to achieve gain stabilization, which automatically adjusts the high voltage so that the gamma peaks are recorded in the same channel under all operating conditions. See FIGS. 4A-4C.

(e) Dual detection. In the MCA of the present invention when dual detection is enabled two types of radiation signals are captured. The spectral channels on the MCA of the present invention are reduced by a factor of two for each type of radiation signal.

(f) Coincidence counting and coincidence mode. Frequently multiple detectors are used in parallel. Sometimes scattering can make multiple detectors detect radiation that originated from a single photon. Coincidence mode (FIG. 3) would allow the detectors to communicate and to determine when photons originated from the same source. The multichannel analyzer of the present invention is configured to perform coincidence counting. This allows event-timing to occur between separate detectors. If signals are registered on more than one detector within a specific time-gate, they are considered coincident by the MCA. The resulting pulses are either summed or discounted depending on the detection needs of the user.

(g) Advanced Cockcroft-Walton voltage multiplier (CWVM). The traditional Cockcroft-Walton voltage multiplier exhibit linearity issues due to current “sag” in high-count rate fields. As the current increases at high count rates, Cockcroft-Walton voltage multipliers cannot sustain the output voltage. The voltage drops and therefore, the gain drops. Commercial Cockcroft-Walton voltage multiplier designs only use half the cycle of the AC current, which is provided to the voltage multiplier stage. Thus, it is essentially only on for half the time. The present invention may use the full cycle to more efficiently distribute power to the scintillation detector allowing for further reduction of power consumption and increased count rate capabilities. This improves the high voltage distribution and eliminates current “sag” currently found in instruments that use the Cockcroft-Walton voltage multiplier.

(h) Voltage-scaling. The MCA may be configured to enable the chip to enter a deep-sleep mode for extreme low power consumption, and to turn it on for readings when it is triggered by, for instance, vibration, light, sound or other physical changes detected.

(i) Operating system agnostic. The MCA is configured to be operating system agnostic. The traditional end-cap systems may only be operated using WINDOWS or APPLE operating systems. These operating systems are not real-time operating systems, resulting in inaccuracy in counting statistics. Particularly, in moderate to high flux environments, the interrupt-driven systems may fail to register events. Furthermore, these operating systems conduct “house cleaning” operations at arbitrary times, which takes precedence over all operations, including data acquisition. This may result in missing of data in a millisecond span. In the case of vehicles traveling between 50 ft/s to 140 ft/s, elevated level of radiation could be completely missed. Therefore, the multichannel analyzer in the present invention, which is operating system agnostic, avoids these disadvantages of the non-real-time operating systems, leading to superior performance over the traditional end-caps.

(j) Smart device integration. The MCA chip may be integrated with a smart device such as a smart phone, tablet computer etc. The smart device is then used to program and control the MCA and read histograms produced thereby.

(k) List-mode. The MCA chip is configured to put time stamps to individual events and to report these events along with their time stamps. This allows the user to perform customized post-processing of spectral data obtained from a plurality of detectors.

(l) Locating. A GPS circuitry may be integrated in the chip, enabling the device to be located and indicating the location where the signal was collected.

Additional features of the MCA may include:

(m) Gain Stabilization Thresholds. The gain stabilization algorithm will indicate to increase or decrease the fine gain regardless of how much the differences between the two windows is. Instead, there could be a threshold set such that unless the difference between the two windows exceeds a certain threshold, then the algorithm will state no change.

(n) Direct Memory Access (DMA). Direct Memory Access mode would allow the microcontroller to send a read histogram command, and then the MCA would read out the histogram without requiring the handshake protocol. The MCA would output a histogram value every clock cycle until it had read out the entire histogram.

(o) Generic Counters. In the radiation detection field there is often a need to count a variety of events. It would be beneficial for the MCA to contain at least one and preferably two or more generic counters that could be used to count the rise or fall of any event of interest.

The MCA ASIC provided herein comprises the following features:

### Inputs

Clock—1 bit

Clocks the MCA.

Active: Rising Edge
Reset—1 bit

Resets the MCA to the initialized state. When raised high, all registers, counters, and memory blocks will be set to 0.

Active: Low
Incoming Energy Data (ADC bus)—12 bit

Carries the energy value of a received radiation particle or ray.

Active: 0—Low, 1—High
LLD—1 bit

Lower Level Discriminator, when the analog to digital converter begins to convert a signal this signal will be raised, but it does not last the entire conversion process. The LLD pulses are counted by the Gross Counter.

Active: High
ADC Busy—1 bit

This signal is raised part of the way through the conversion process, and when it falls it signals that the conversion is finished, and the value from the analog to digital converter is ready to be read.

Active: High
Energy Peak Detected—1 bit

When the analog value reaches its maximum, this pulse is raised. Energy Peak Detect is not a long pulse but it must be longer than a single clock cycle. If multiple photons are detected, and therefore multiple peaks during one LLD/busy cycle, this creates pulse pile up. Energy Peak Detected pulses should be longer than at minimum one clock cycle.

Active: Rising Edge
Sync In—1 bit

The signal is raised to indicate that the MCA needs to switch memory banks.

Active: Rising Edge
Micro Write—1 bit

Raised by the microcontroller to tell the MCA that it has a value for it to read.

Active: Rising Edge
Micro Acknowledge—1 bit

When the MCA writes a value to the microcontroller, the microcontroller raises this line after each 16-bit readout is completed to indicate it has received the value

Active: Rising Edge
Enable Data Collection—1 bit

When high the MCA is operating, when low it can accept commands and change parameters.

Active: High
Dual Detection—1 bit

When detecting multiple types of signals.

Active: 0—Low (Stores data in lower half of histogram), 1—High (Stores data in upper half of histogram).

### Outputs

MCA write—1 bit

Primary Function: Raises to signal to the microcontroller that it has written a value.

Active: Rising Edge

Additional Function: During reset, MCA Write will be held high until the memory has been cleared, and the MCA is ready to collect data.

Active: High
Reading or Clearing Short Term Histogram—1 bit

Output is high when the short-term histogram is being read or being cleared. Otherwise it is low.

Active: High
Reading or Clearing Long Term Histogram—1 bit

Output is high when the long-term histogram is being read or being cleared. Otherwise it is low.

Active: High

### Interrupts (Outputs)—2 Pins

Sync Out/Read Required Interrupt—1 bit

When in Free Run Mode, the microcontroller is not signaling when to switch memory banks, the MCA will decide when to sync and outputs the sync. The Sync Out is sent to the other MCA units if multiple detectors are being used. The Sync Out also notifies the micro controller to read the histogram. If running List mode, notifies the micro controller that the MCA has data that must be read out. This interrupt is generated when the memory becomes half filled.

Active: Rising Edge
Error Interrupt—1 bit

This interrupt is raised when the MCA detects an error. The most common case occurs when the micro controller attempts to write a command that is determined to be invalid given the state of the MCA. For more detail, see the Error Code section.

Active: Rising Edge

### InOut—17 Pins

Mcu Bus—16 bit

Bus between the micro controller and MCA. The MCA writes data out to the micro controller, and the micro controller writes commands and data to the MCA.
Active: 0—Low, 1—High
Bus Controller—1 bit

Determines whether the Bidirectional Bus InOut is in use or is available for use. High corresponds to neither the MCA or micro controller having control of the Bidirectional Bus InOut, and both the MCA and micro controller can pull the Bus Controller low to show control of the Bidirectional Bus InOut. There should be a pullup resistor connected to the Bus Controller to pull the line up to VddExt.

Active: 0—In Use, 1—Free to Use
Total—47 pins

### Registers

### Enable/Disable Register

These registers enable/disable their corresponding modes. The corresponding mode is enabled when the register has a value of 1 and disabled when the register has a value of 0. The size of each of these registers is 1 bit. All registers are initialized to 0 during reset.
Enable Pulse Pile Up

When enabled values are recorded at the fall of ADC Busy Input only if Energy Peak Detected Input had one rising edge (the falling edges are not tracked) during the LLD/Busy cycle. When disabled values are recorded at the fall of ADC Busy Input regardless of how many Energy Peak Detected Input rising edges occurred.

Corresponding Mode: Pulse Pile Up Mode

Default Value When Reset: 0 (disabled)
Enable Dual Detection

When enabled the MCA will replace the most significant bit of the Incoming Energy Data Energy Peak Detected Input with the value of the Dual Detection Input pin. When disabled, this behavior will not persist, and the MCA will operate as usual.

Corresponding Mode: Dual Detection Mode

Default Value When Reset: 0 (disabled)
Enable Free Run

When enabled the MCA runs off of only its internal timer, and outputs when to sync (switch memory banks). When disabled the MCA switches memory banks when it receives a pulse from its sync input.

Corresponding Mode: Free Run Mode

Default Value When Reset: 0 (disabled)
Enable Gain Stabilization

When enabled, the gain stabilizer performs the Gain Stabilization Algorithm. When disabled the gain stabilizer does not do anything.

Corresponding Mode: Gain Stabilization Mode

Default Value When Reset: 0 (disabled).

### Parameter Registers

These registers set parameters that are used by the MCA. The registers have varying sizes. All registers are initialized to 0 during reset.
Short Term Histogram Conversion Gain

Data coming in may not always be a 12-bit value. The Short-Term Histogram Conversion Gain Register can be set to right shift the incoming data and compress the data. The Short-Term Histogram Conversion Gain Register is only applied to data that is stored in either Memory Bank 1 or Memory Bank 2.

Size: 16 bits.

Note: If Dual Detection Mode is enabled, the Short-Term Histogram Conversion Gain Register must be at least one.

Default Value When Reset: 0
Long Term Histogram Conversion Gain

Data coming in may not always be a 12-bit value. The Long-Term Histogram Conversion Gain Register can be set to right shift the incoming data and compress data. The Long-Term Histogram Conversion Gain is only applied to data that is stored in Memory Bank 3.

Size: 16 bits.

Note: If Dual Detection Mode is enabled, the Long-Term Histogram Conversion Gain Register must be at least one.

Default Value When Reset: 0
Gain Stabilization Channel

Sets the desired channel on which to perform the gain stabilization algorithm. This register must be set to a value other than 0 while using the Gain Stabilization Mode. The Gain Stabilization Algorithm goes into greater detail.
Size: 16 bits.

Note: The Gain Stabilization Channel is not shifted by the Short-Term Histogram Conversion Gain and Long-Term Histogram Conversion Gain.

Default Value When Reset: 0
Gain Stabilization Window Width

Determines how many channels above and below the Gain Stabilization Channel Register to include when calculating the Gain Stabilization Mode increase or decrease. Both ranges, above and below, the Gain Stabilization Channel Register each include this many channels. This register must be set to a value other than 0 while using the Gain Stabilization Mode. The Gain Stabilization Algorithm, goes into greater detail.

Size: 16 bits.

Note: The Gain Stabilization Window is not shifted by the Short-Term Histogram Conversion Gain Register and Long-Term Histogram Conversion Gain Register.

Default Value When Reset: 0
Low Level Cutoff

The lower energy levels, often the lowest 5 to 10 memory locations, are unneeded for detection. This value is set to determine the threshold for acceptable energy levels.

Size: 16 bits.

Note: Both the Short-Term Histogram Conversion Gain Register and the Long-Term Histogram Conversion Gain Register are applied before the Low Level Cutoff Register when determining the value to store in the histogram.

Default Value When Reset: 0
Free Run Timer

Sets the number of clock cycles to count before switching memory band and signaling Sync Out Interrupt. When the Free Run Timer Register is set, only the most significant 16 bits are writeable. Therefore, for each increase in the value that is written to the Free Run Timer, a user increases the time of read out by

$$\frac{{2}^{16}}{Clock Rate ( Hz )} s .$$

For a 10 MHz clock this comes out to 0.00655 s.

Size: 32 bits.

Default Value When Reset: 0
Short Term Histogram Start

Sets the memory address of where the short-term histogram will start being read out.

Size: 16 bits.

Default Value When Reset: 0
Short Term Histogram Size

Sets the number of channels read out through the short-term histogram. Each channel is four bytes and requires two reads. The short-term histogram begins at the address of the Short-Term Histogram Start Register and continues through (includes) Short Term Histogram Start Register+Short Term Histogram Size Register−1.

Size: 16 bits.

Default Value When Reset: 4096
Long Term Histogram Start

Sets the memory address of where the long-term histogram will start being read out.

Size: 16 bits.

Default Value When Reset: 0
Long Term Histogram Size

Sets the number of channels read out through the long-term histogram. Each channel is four bytes, and requires two reads. The long-term histogram begins at the address of the Long Term Histogram Start Register and continues through (includes) Long Term Histogram Start Register+Long Term Histogram Size Register−1.

Size: 16 bits.

Default Value When Reset: 4096

### Counters

Gross Counter

Counts LLD Input rising edges and counts the total number of readings that have been recorded.

Number of Bits: 32

Value When Reset: 0
Pulse Pile Up Counter

Counts Energy Peak Detected Input rising edges, and determines if a reading is valid, and therefore can be stored in the histogram. There should only be one Energy Peak Detected Input rising edge for every LLD Input/ADC Busy Input cycle. For greater detail on Pulse Pile Up Mode and the Pulse Pile Up Counter please see section.

Number of Bits: 32

Value When Reset: 0
Dead Time Counter

Keeps track of the amount of time the MCA is working. Works by counting positive clock edges while LLD Input or ADC Busy Input are high.

Number of Bits: 32

Value When Reset: 0

### Critical and Non-Critical Errors

There are two types of errors, Critical and Non-Critical, described as the error's Impact. Critical Errors prevent the MCA from functioning correctly, and as a result the MCA halts until the error is corrected. Non-Critical Errors do not prevent the MCA from operating; however, they can inform the micro controller of changes that may need to be made to improve operation, or warn the micro controller of a condition that has occurred. The most significant bit, bit 15 (least significant bit is bit 0), of Error Register 1 identifies whether or not an error is critical and is called the Critical Error Bit.

Critical Error Bit: 1, Critical Error

Critical Error Bit: 0, Non-Critical Error.
Error Registers

When parameters are not set correctly, each of these errors occurs once when Enable Data collection input is pulled from low to high. When Enable Data Collection Input is pulled high the error checking sequence will begin. If the given condition is not met, then the error protocol will ensue, and the bits will be marked to inform the user which conditions were not met.

When incorrect commands are used with the enable data collection high, each of these errors is generated by issuing a command that requires enable data collection input to be low. In each of these cases the respective registers are not changed, but instead the error protocol ensues.

When commands are issued to disabled modes, which occur during operation and sending certain commands during an inappropriate time, the error protocol is immediately triggered after the error protocol is completed and operation will resume.

Resetting or Changing Parameters and/or Modes
Resetting

1. Pull Reset Input low: Reset Input should be held low for a few clock cycles. This will reset all of the counters and registers. Once the system is resetting the MCA Write Output will go high. MCA Write Output will stay high until the system is ready to operate. During this time Enable Data Collection Input should be low.

2. Raise Reset Input: Pull reset high. Once reset is pulled high, the on-chip memory will be reset. This will take 212, 4096, clock cycles to clear the memory. This is represented in the timing diagram by Memory Clearing. During this time data cannot be collected. Enable Data Collection Input should remain low.

3. Set Parameters/Enable Modes: All commands to set parameters should be passed while Enable Data Collection Input is low, and Reset Input is high. Therefore, set all parameters now. Any modes that should be enabled should also be enabled now. It is not required to set any parameters or enable any modes.

4. Wait for MCA Write Input to fall: MCA Write Output will stay high until the memory is reset on the MCA and the MCA is fully operational. Once MCA Write Output is low the MCA is ready to collect data.

5. Pull Enable Data Collection Input high: Now all of the counters and registers have been reset, the memory has been reset, and all of the parameters have been set it is time start operation. Data will not be collected until Enable Data Collection Input is pulled high. Pull Enable Data Collection Input high to begin operation. If any parameters were not set correctly, once Enable Data Collection Input is high, the error checking will begin. If any errors occurred the MCA will be notified.
Changing parameters

1. Lower Enable Data Collection Input: Parameters can only be set while the MCA is not collecting data. Therefore, first lower Enable Data Collection. If a user attempts to set parameters while Enable Data Collection is high, it will result in an error.

2. Set Parameters/Enable Modes: All commands to set parameters should be passed while Enable Data Collection is low. Therefore, set all parameters now. Any modes that should be enabled should also be enabled now.

3. Raise Enable Data Collection Input: Operation is ready to resume. Data will not be collected until Enable Data Collection is pulled high. Pull Enable Data Collection high to begin operation. If any parameters were not set correctly, once Enable Data Collection is high, the error checking will begin. If any errors occurred the MCA will be notified. When changing modes any parameters associated with that mode must be set as shown in Table 1.

TABLE 1

| Mode Being | |
|---|---|
| Enabled | Parameters/Commands Required |
| Free Run Mode | Enable Free Run, Set Free Run Timer |
| Gain | Enable Gain Stabilization, Set Gain Stabilization |
| Stabilization | Channel, Set Gain Stabilization Window Width |
| Pulse Pile Up | Enable Pulse Pile Up |
| Dual Detection | Enable Dual Detection, Set Conversion |
| | Gain (min. of 1) |

### Clocking

The MCA is run by two synchronized clocks. One clock is applied externally, and the other is a faster clock created internally by a Phase Locked Loop. The clock rate is from 5 Mhz to about 20 Mhz. Lower clock rate enables low power design for the single-chip structure. The external clock must be at least as fast as the rate at which the ADC converts values. If this condition is not met, part of data may be lost.

### Gain Stabilization Algorithm

The Gain Stabilization Algorithm calculates whether to increase, decrease, or not modify the gain on the pre-amplifier of the detector. The algorithm uses the Gain Stabilization Channel Register and the Gain Stabilization Window Width Register.

Algorithm:
Lower Sum=Σ_{i=GainStabilization Channel-Gain Stabilization Window Width}^{GainStabilization Channel-1}Counts[i]
Upper Sum=Σ_{i=GainStabilization Channel+1}^{GainStabilization Channel+Gain Stabilization Window Width}Counts[i]
if Upper Sum>Lower Sum

output 1, decrease pre-amp gain
else if Upper Sum<Lower Sum

output 2, increase pre-amp gain
else

output 0, no adjustment

### Pulse Pile Up Distinction

In high count environments it is common for multiple radiation strikes to occur before a detector can process the initial strike. This results in pile up and the resulting digital value is likely corrupted. For proper detection, only one Energy Peak Detected Input is expected, therefore when multiple Energy Peak Detected pulses are seen within a single LLD Input/ADC Busy Input cycle pile up has been detected. When the MCA is running in Pulse Pile Up Mode, reading that have detected pile up will not be recorded in either histogram, and the Pulse Pile Up Counter will increase.

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### EXAMPLE 1

### Receiving Detector Data

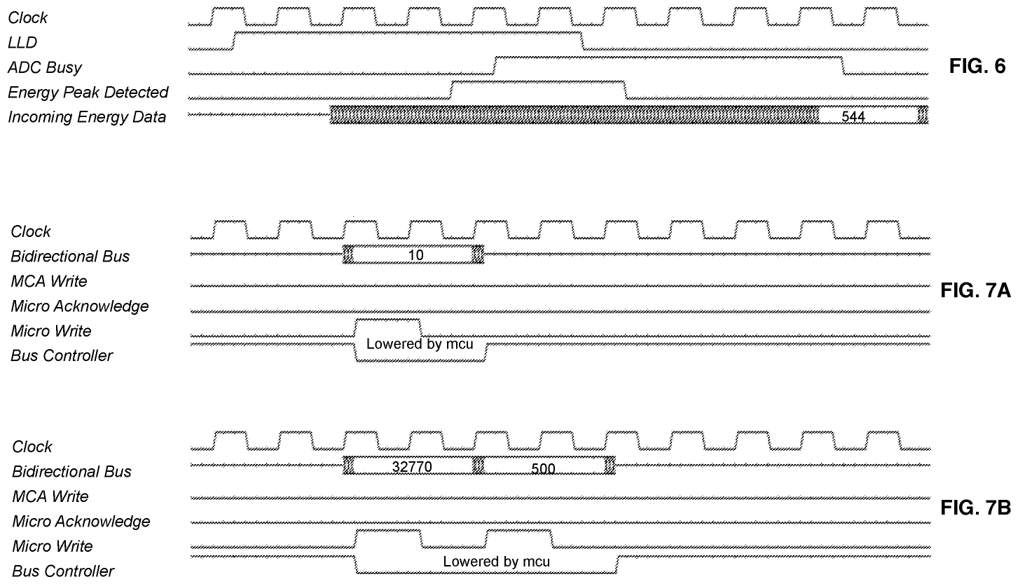

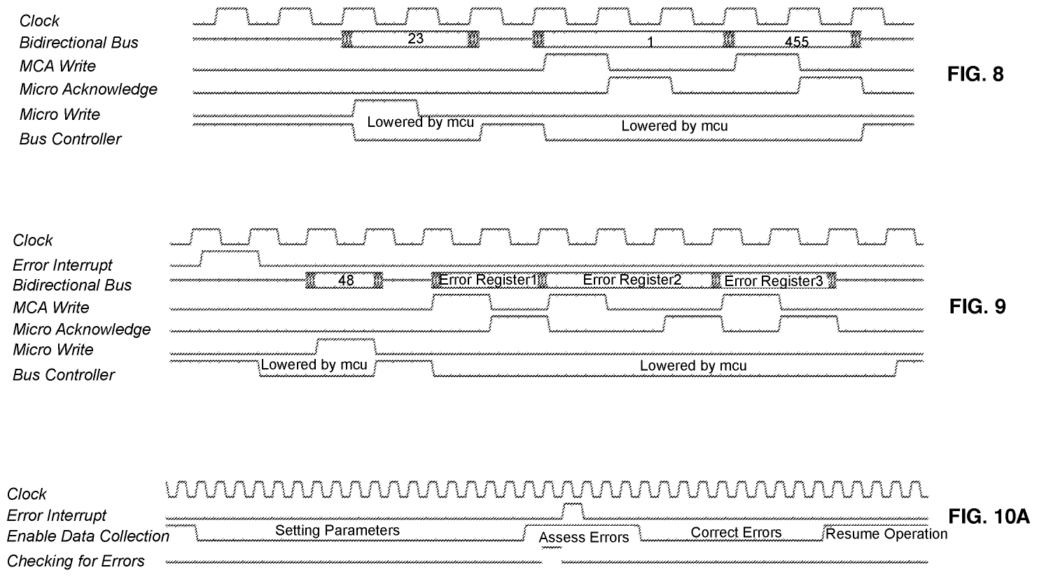

As shown in FIG. 6, the first signal to rise is the Lower Level Discriminator (LLD) Input. The Gross Counter uses the LLD Input to determine how many radiation particles have been detected. The rising order between first analog to digital converter (ADC) Busy Input and Energy Peak Detected Input is not essential, however the falling edge of ADC Busy Input should come after the falling edge of Energy Peak Detected Input. The Incoming Energy Data Input is recorded in the MCA at the first rising edge of the Clock Input after the falling edge of ADC Busy Input. An LLD Input/ADC Busy Input cycle is the time from the rising edge of LLD Input to the falling edge of ADC Busy Input. Multiple Energy Peak Detected Inputs may appear within a single LLD Input/ADC Input cycle. When this happens, the detector is detecting radiation faster than it can digitize, and the result is a pile up of detections whose resulting value is likely incorrect. This condition is addressed in Pulse Pile Up Mode. It is to be noted that all signals are not restricted to the time duration shown in FIG. 8 and can last many more clock cycles then shown. LLD and ADC Busy are long signals, while Energy Peak Detected is a shorter signal. Energy Peak Detected must be guaranteed to be greater than a clock cycle.

### EXAMPLE 2

### Micro Controller Writing to MCA

FIG. 7A illustrates the protocol to send a command without a data packet from the micro controller to the MCA. Firstly, the micro controller takes control of the Bidirectional Bus InOut by lowering the Bus Controller InOut. Secondly, the micro controller loads the command onto the Bidirectional Bus InOut. Thirdly, the micro controller sends a Micro Write Input to inform the MCA that it has written a command. The MCA will read the data on the Bidirectional Bus InOut on the first rising clock edge after the rising edge of Micro Write Input. The micro controller does not have to wait for a notification from the MCA that the command was received. The micro controller then releases the Bus Controller InOut.

FIG. 7B illustrates the protocol to send command with a data packet from the micro controller to the MCA. Firstly, the micro controller takes control of the Bidirectional Bus InOut by lowering the Bus Controller InOut. Secondly, the micro controller loads the command onto the Bidirectional Bus InOut. When using Protocol 2, which sends a data packet, the most significant bit of the Bidirectional Bus InOut must be 1. This informs the MCA to expect a data packet. To accomplish this OR the command with 0x8000. Thirdly, the micro controller sends a Micro Write Input to inform the MCA that it has written a command. The MCA will read the data on the Bidirectional Bus InOut on the first rising clock edge after the rising edge of Micro Write Input. The micro controller does not have to wait for a notification from the MCA that the command was received. Then the micro controller loads the desired data packet onto the Bidirectional Bus InOut. Next the micro controller sends a Micro Write Input to inform the MCA that it has written a data packet. The MCA will read the data on the Bus Controller InOut on the first rising clock edge after the rising edge of Micro Write Input. The micro controller then releases the Bus Controller InOut. The MCA will decipher the command and perform the needed action.

### MCA Reading Data Out to the Micro Controller

FIG. 8 illustrates the protocol when the micro controller writes the command to the MCA, Read Dead Time Counter Command, command 23. The MCA will read out the Dead Time Counter Counter in two phases. The first phase will be the most significant 16 bits, and the second phase will be the least significant 16 bits. Therefore, the MCA is reading out a Dead Time Count of 65991. Once the MCA receives a command, it will wait until the Bus Controller InOut is high to proceed. Once the Bus Controller InOut is high the MCA will lower the Bus Controller InOut to take control of the Bidirectional Bus InOut and load the most significant 16 bits onto the Bidirectional Bus InOut. Once the MCA has put the data on the Bidirectional Bus InOut it will raise the MCA Write Output to signal to the micro controller that it has written out data. Then the MCA waits to receive a Micro Acknowledge Input from the micro controller. Once a Micro Acknowledge Input is received, the MCA will load the least significant bits of data onto the Bidirectional Bus InOut. Once the MCA has put the data on the Bidirectional Bus InOut it will raise the MCA Write Output. The micro controller will send a Micro Acknowledge Input once it has read the data. Because the Dead Time Counter Counter is only reads a 32-bit counter, the MCA will be finished with the Read Dead Time Counter Command after 2 read outs. If the command were instead a Read Short Term Histogram Command, then there would be many more MCAs read out and micro controller acknowledge cycles. The micro controller is responsible for knowing how many pieces of data it will need to read for each command. For each read out, or memory address, the MCA will always read out first the most significant bits, followed by the least significant bits. The number of reads is provided in the documentation. Once there is no more data to write, the MCA will free the Bus Controller InOut and is available to receive commands. It is important to note that Protocol 3 requires confirmation from the micro controller to proceed, whereas Protocol 1 and Protocol 2 require no such confirmation. Protocol 3 requires a confirmation step because the micro controller may be busy handling other task and may be incapable of immediately reading the value from the MCA.

### EXAMPLE 3

### MCA Reads Out Error Registers

As shown in FIG. 9, the Error Code is written out in 48 bits, so 3 read outs are required. Command 48 is Read Error Registers. This command makes the MCA read out the three Error Registers. The three read outs are denoted by Error Register 1, Error Register 2, and Error Register 3. Each of the bits in the Error Codes corresponds to a particular error. Each of these errors and their respective bit positions are shown in FIG. 9.

Any time an error is detected, first the Error Interrupt Interrupt is thrown high, to notify the micro controller that an error has occurred. The MCA then waits for the micro controller to send the MCA the Read Error Registers Command, command 48. Once the MCA has received the command it will load Error Register 1 on the Bidirectional Bus InOut and send an MCA Write Output. Once the MCA receives a Micro Acknowledge Input it will load Error Register 2 onto the Bi-Directional Bus InOut and send an MCA Write Output. Once the MCA receives a Micro Acknowledge Input it will load Error Register 3 onto the Bi-Directional Bus InOut and send an MCA Write Output. The MCA then waits again to see the Micro Acknowledge Input. The Error Protocol, Protocol 4, is now finished and it is the micro controller's job to correct any error.

Multiple errors may occur simultaneously, therefore more than one bit can indicate an error. Errors are indicated by having a 1 in the position of the error, and a 0 in the positions where there is no error. Any time an error is detected, the whole error protocol must be completed. Although this may include reading empty registers, it is more efficient than queuing individual errors that each requires a read.

### EXAMPLE 4

### Interaction of Micro Controller and MCA: Critical Errors

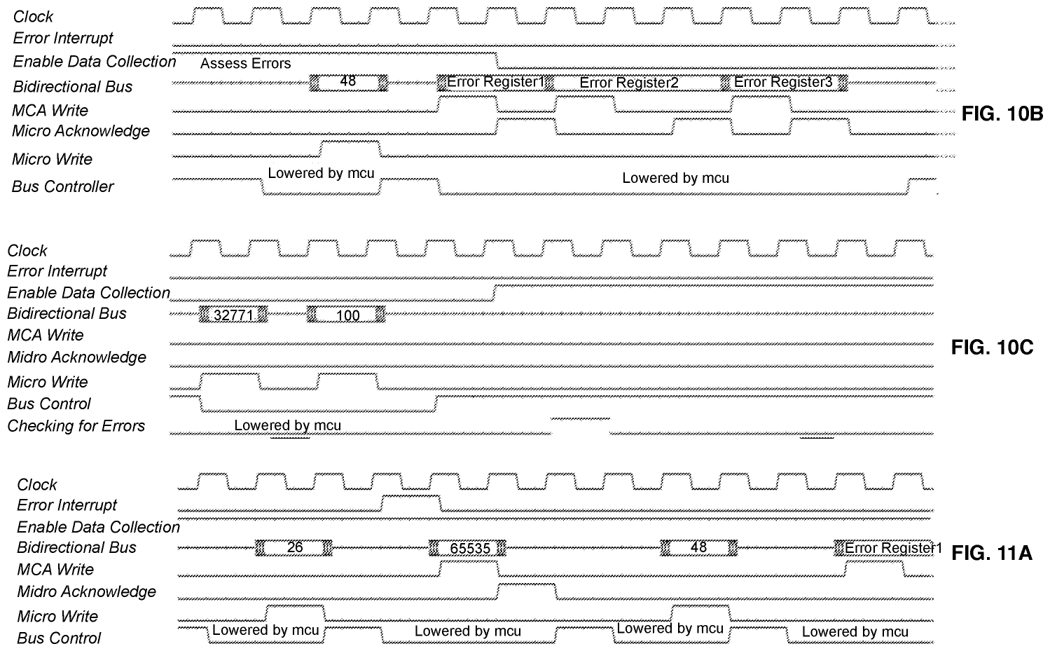

As shown in FIG. 10A, when Critical Errors occur, the micro controller needs to lower Enable Data Collection Input, assess the errors, and reset any parameters that need to be changed. Critical Errors are always the result of setting parameters that are incompatible with the desires settings. As an example, when Enabl(ing) Gain Stabilization Command and Set(ting) Gain Stabilization Channel Command, but a user forgets to Set Gain Stabilization Window Width Command, the Gain Stabilization Algorithm cannot operate because it has no window to observe. FIG. 10 illustrates the behavior between the micro controller and MCA that will occur when a Critical Error is detected from setting incorrect parameters.

Generally, FIG. 10A represents the behavior between the micro controller and MCA that will occur when a Critical Error is detected from setting incorrect parameters. FIG. 10B expands the Assess Errors and Correct Errors. As in FIG. 9, command 48 is Read Error Registers which causes the MCA to read out the three Error Registers. Once the MCA reads Error Register 1, it will see that the error is a Critical Error, and therefore it knows that it needs to lower Enable Data Collection.

Continuing with the example of Enabl(ing) Gain Stabilization and Set(ting) Gain Stabilization Channel, but not Set(ting) Gain Stabilization Window Width, then the Error Registers would have been:

Error Register 1: 0x8002=16′b 1000 0000 0000 0100;

Error Register 2: 0x0000=16′b 0000 0000 0000 0000; and

Error Register 3: 0x0000=16′b 0000 0000 0000 0000.
This can be decoded and shows that the error was Gain Stabilization Window Width Equal to Zero with Enable Gain Stabilization High. This is a Critical Error because the most significant bit of Error Register 1 is a 1. Continuing from the timing diagrams in FIGS. 10A-10B, FIG. 10C illustrates the command Set Gain Stabilization Window Width. Command 32771 is Set Gain Stabilization Window Width Command, 3|0x8000. The data packet contains the value 100, which will make Gain Stabilization Window Width Register to be 100. Checking for Errors is not an actual signal, but rather indicates time wise when the MCA checks for errors with recently set parameters. Once the micro controller has assessed the error, and has set the needed parameters, it raises Enable Data Collection Input. Once again, the MCA checks for errors, however this time it sees that the needed parameters have been set, and therefore does not signal an error. Once this is complete, the MCA begins to operate as expected.

### EXAMPLE 5

### Interaction of Micro Controller and MCA: Non-Critical Errors

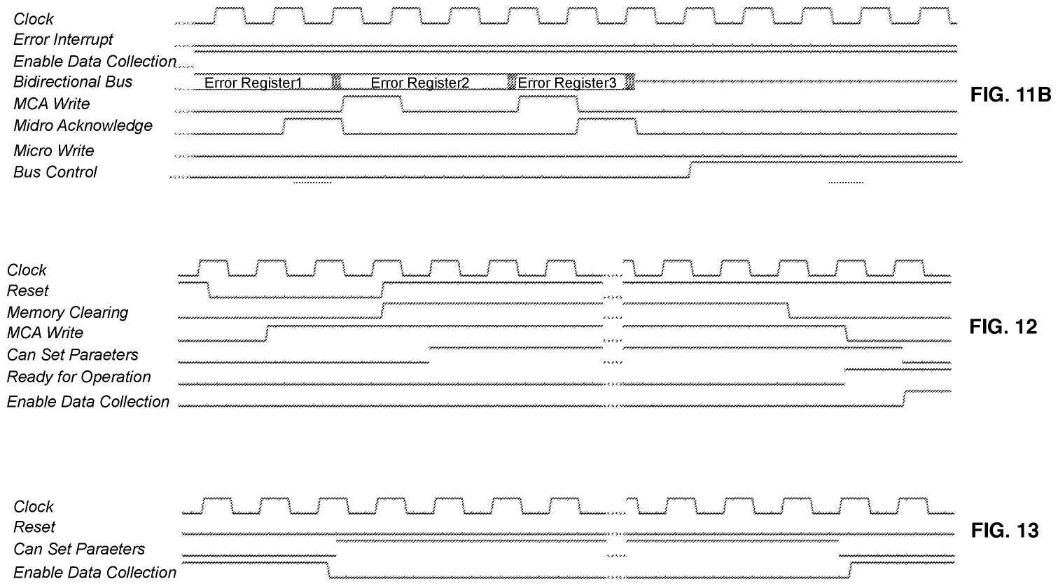

As shown in FIGS. 11A and 11B, when non-Critical Errors occur, the micro controller needs assess the errors and determine what action lead to the error. For Non-Critical Errors the micro controller does not need to lower Enable Data Collection Input. Non-Critical Errors are the result of attempting to read values that correspond to modes that are not enabled, or other run time errors. As an example, when Read(ing) Pulse Pile Up Counter Command but you have not Enable(d) Pulse Pile Up Command. Therefore, this is a run time error, and the read will return 0xFFFF. This is shown as:

Error Register 1: 0x0002=16′b 0000 0000 0000 0000;

Error Register 2: 0x0000=16′b 0000 0000 0000 0000; and

Error Register 3: 0x0000=16′b 0000 0000 0000 0001.

The micro controller attempts to Read Pulse Pile Up Counter Command, and receives 0xFFFF, indicating that it was disabled, and in addition the MCA signals the Error Interrupt. The micro controller then reads the Error Registers Register to find out the error was Read/Read and Clear/Clear Pulse Pile Up Counter Command with Pulse Pile Up Register Disabled Error. This can be decoded and shows that the error was, Read/Read and Clear/Clear Pulse Pile Up Counter Command with Pulse Pile Up Register Disabled Error. It is a Non-Critical Error because the most significant bit of Error Register 1 is a 0. If the micro controller intended to have Enable(d) Pulse Pile Up Command, it will now need to go Enable Pulse Pile Up Command. Otherwise, since this is a Non-Critical Error it does hinder operation and does not require any action. Note that the micro controller was not required to lower Enable Data Collection.

### EXAMPLE 6

Resetting or Changing Parameters and/or Modes

As shown in FIG. 12, once reset is pulled high, the on-chip memory will be reset. This will take 212, 4096, clock cycles to clear the memory. This is represented in the timing diagram by Memory Clearing. During this time data cannot be collected. Enable Data Collection Input should remain low. Memory Clearing is internal to the MCA. Can Set Parameters and Ready for Operation are not actual signals, but rather indicate time wise when certain operations can take place.

As shown in FIG. 13, parameters can only be set while the MCA is not collecting data. Can Set Parameters is not an actual signal, but rather indicates time wise when certain operations can take place. This time diagram is assuming that the MCA was reset when turned on, and that the user is changing parameters during operation.

### EXAMPLE 7

### Gain Stabilization Algorithm

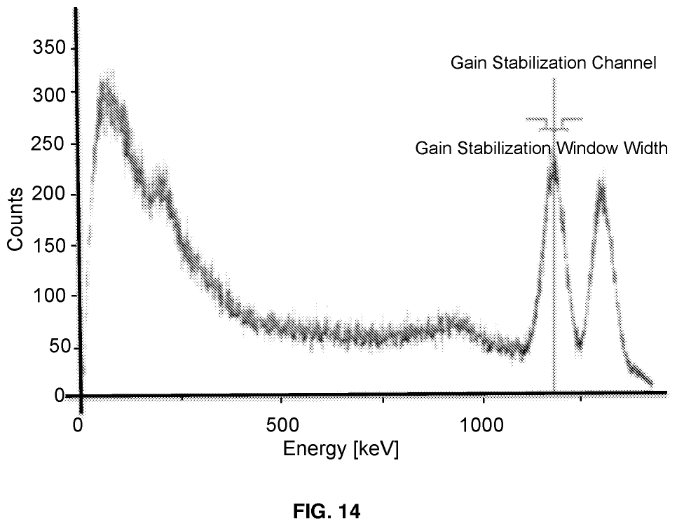

As shown in FIG. 14, the Gain Stabilization Channel Register is the desired local maximum that you are trying to stabilize your spectrum around. The Gain Stabilization Window Width Register is the number of channels both below and above the Gain Stabilization Channel Register that will be included in the calculation.

### EXAMPLE 8

### Pulse Pile Up Distinction

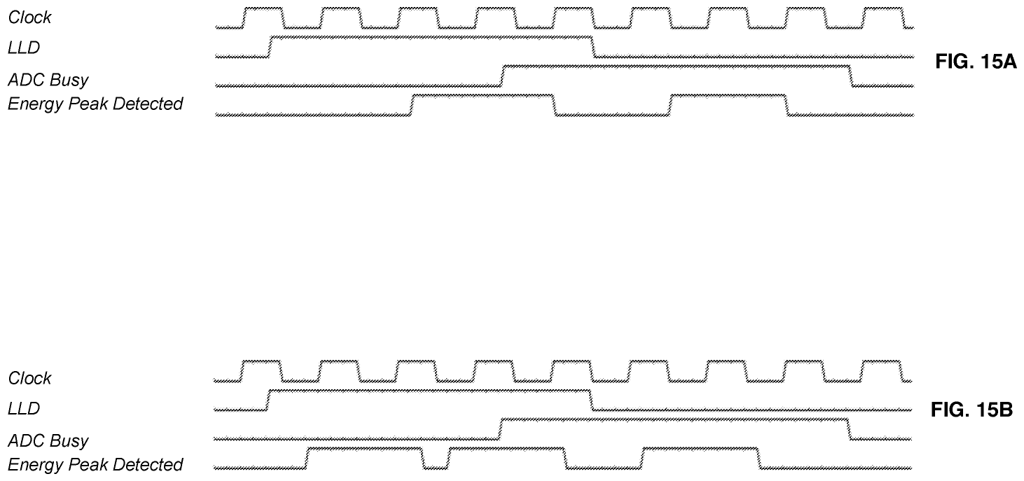

As shown in FIG. 15A, within a single LLD Input/ADC Busy Input cycle two Energy Peak Detected Input pulses are seen. The first Energy Peak Detected Input is expected, and therefore the Pulse Pile Up Counter does not add any to the counter. The second Energy Peak Detected Input identifies pile up, and the reading is discarded. Also, the Pulse Pile Up Counter adds one to itself for the second Energy Peak Detected Input.

As shown in FIG. 15B, within a single LLD Input/ADC Busy Input cycle three Energy Peak Detected Input pulses are seen. The first Energy Peak Detected Input is expected, and therefore the Pulse Pile Up Counter does not add any to the counter. The second Energy Peak Detected Input identifies pile up, and the reading is discarded. Because there are two extra Energy Peak Detected Input pulses, the Pulse Pile Up Counter adds two to itself.

The present invention is well adapted to attain the ends and advantages mentioned as well as those that are inherent therein. The particular embodiments disclosed above are illustrative only, as the present invention may be modified and practiced in different but equivalent manners apparent to those skilled in the field having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention.

1. A multi-channel analyzer (MCA) for a radiation detection system, comprising:
an application specific integrated circuit (ASIC) chip comprising at least one instance of the multi-channel analyzer with a plurality of multi-channel analyzer functions integrated thereon, said application specific integrated circuit chip in electrical connection with a microcontroller interfaced with a host electronic device.

2. The multi-channel analyzer of claim 1, said ASIC chip further comprising an analog-to-digital converter integrated therein.

3. The multi-channel analyzer of claim 1, said ASIC chip further comprising a microcontroller unit integrated therein.

4. The multi-channel analyzer of claim 1, said ASIC chip further comprising an analog-to-digital converter and a microcontroller unit integrated therein.

5. The multi-channel analyzer of claim 1, said ASIC chip further comprising a GPS integrated therein.

6. The multi-channel analyzer of claim 1, said ASIC chip further comprising at least one event counter.

7. The multi-channel analyzer of claim 1, said ASIC chip comprising a double buffered memory integrated therein.

8. The multi-channel analyzer of claim 1, said ASIC chip configured to enable at least one function comprising:
a synchronized readout function;
a rejection of pulse pile up function;
a gain stabilization function;
a dual detection of radiation signals function;
a coincidence counting function;
a voltage multiplier to use a full cycle of AC current;
a voltage scaling function;
a list-mode function to time stamp and report events;
an analog-to-digital signal conversion;
a digital-to-analog signal conversion; or
a voltage scale for a deep-sleep mode for significantly low power and energy consumption.

9-10. (canceled)

11. The multi-channel analyzer of claim 8, wherein said gain stabilization function enables an algorithm comprising processor-executable instructions to maintain a gain threshold.

12-19. (canceled)

20. The multi-channel analyzer of claim 1, wherein said ASIC chip comprises 2 or more instances of the MCA.

21. The multi-channel analyzer of claim 1, wherein the MCA has a direct memory access mode.

22. The multi-channel analyzer of claim 1, wherein the MCA is operating system agnostic.

23. The multi-channel analyzer of claim 1, wherein the host electronic device is a computer, a laptop computer, a tablet computer, a smart phone, or other electronic device.

24. A multi-channel analyzer for a radiation detection system comprising:
a multi-functional application specific integrated circuit (ASIC) chip integrating thereon at least one of an analog-to-digital converter and a microcontroller unit and comprising circuitry configured to enable one or more multi-channel analyzer functions.

25. The multi-channel analyzer of claim 24, further comprising a GPS integrated therein and configured to track a location of the MCA or a location of signals collected by the MCA or a combination thereof.

26. The multi-channel analyzer of claim 24, further comprising at least one event counter.

27. The multi-channel analyzer of claim 24, further comprising a double buffered memory in electrical communication with the ASIC chip.

28. The multi-channel analyzer of claim 24, said ASIC circuitry configured to enable one or more multi-channel analyzer functions to:
synchronize a plurality of detectors in the radiation detection system to collect data therefrom;
detect and reject pulse irregularities in electronic signals resulting from detection of the radiation;
adjust gain to achieve gain stabilization to record radiation peaks in a same channel;
capture two types of radiation signals;
sum or discount signals registered within a specific time-gate; and
interface with a host computer.

29. The multi-channel analyzer of claim 28, wherein said ASIC chip circuitry is configured to:
achieve gain stabilization via an algorithm comprising processor-executable instructions to maintain a gain threshold;
enable a function to eliminate current sag;
enable a list-mode function to add time stamps to individual events in multiple detectors and to report events;
enable a function to use a full cycle of AC current in a voltage multiplier;
enable a function to scale voltage for a deep-sleep mode for significantly low power and energy consumption; or
enable a function to convert an analog signal to a digital signal, to convert a digital signal to an analog signal or a combination thereof; or
a combination thereof.

30-34. (canceled)

35. The multi-channel analyzer of claim 24, wherein the multi-channel analyzer has a direct memory access mode.

36. The multi-channel analyzer of claim 24, wherein said multi-channel analyzer is operating system agnostic.
